(19) United States
(12) Patent Application Publication
(10) Pub. No.: US 2016/0305524 A1
(43) Pub. Date: Oct. 20, 2016

(54) TORQUE CONVERTER FRONT COVER ASSEMBLY PILOT

(71) Applicant: Schaeffler Technologies AG & Co. KG, Herzogenaurach (DE)

(72) Inventors: Michael RESH, Massillon, OH (US); Carleton CALDWELL, Wadsworth, OH (US)

(21) Appl. No.: 14/688,223

(22) Filed: Apr. 16, 2015

(51) Int. Cl. F16H 41/24; F16H 41/28

(52) U.S. Cl. CPC F16H 41/24; F16H 41/28

(57) ABSTRACT

A torque converter cover assembly is provided. The torque converter cover assembly includes a front cover for facing an engine crankshaft and a pilot configured for aligning the front cover with the engine crankshaft. The pilot including a base end fixed to the front cover and a tapered section extending from the base end. The tapered section decreasing in size radially as the pilot extends axially away from the front cover. A method of forming a torque converter is also provided.

The present disclosure relates generally to torque converters and more specifically to torque converter front cover assembly pilots for aligning with crankshafts.

### BACKGROUND

Currently, torque converter cover pilots are extruded out of the cover or are have a standard T-shape design. An example of an extruded pilot is shown in U.S. Pat. No. 6,651,330. U.S. Pat. No. 7,997,072 discloses a stamped pilot welded to a cover.

### SUMMARY OF THE INVENTION

A torque converter cover assembly is provided. The torque converter cover assembly includes a front cover for facing an engine crankshaft and a pilot configured for aligning the front cover with the engine crankshaft. The pilot including a base end fixed to the front cover and a tapered section extending from the base end. The tapered section decreasing in size radially as the pilot extends axially away from the front cover.

A method of forming a torque converter is also provided. The method includes forming a front cover assembly including a front cover for facing an engine crankshaft and a pilot configured for aligning the front cover with the engine crankshaft. The pilot includes a base end fixed to the front cover and a tapered section extending from the base end. The tapered section decreases in size radially as the pilot extends axially away from the front cover.

### BRIEF DESCRIPTION OF THE DRAWINGS

The present invention is described below by reference to the following drawings, in which:

FIG. 1 shows a torque converter aligned with an engine crankshaft in accordance with an embodiment of the present invention.

### DETAILED DESCRIPTION

In order to improve durability of a friction weld, the present disclosure provides an embodiment of pilot including a frustoconical shape, a free end for crankshaft mounting and a wider base for additional projection weld contact. If the area of the weld between the pilot and cover of the torque converter is too small then the weld can fail while the pilot is aligning the torque converter to the engine which can cause the entire power train system to fail. If the pilot is not the desired size then the torque converter will not fit in the corresponding power train system and this will not function. The embodiment of the pilot described below provides strength in the pilot weld area of front cover assembly of the torque converter while also meeting the requirements for pilot size and envelope. The shape of pilot may provide a sufficient projection weld area, may eliminate weak points and provides a pilot fitting into the corresponding envelope.

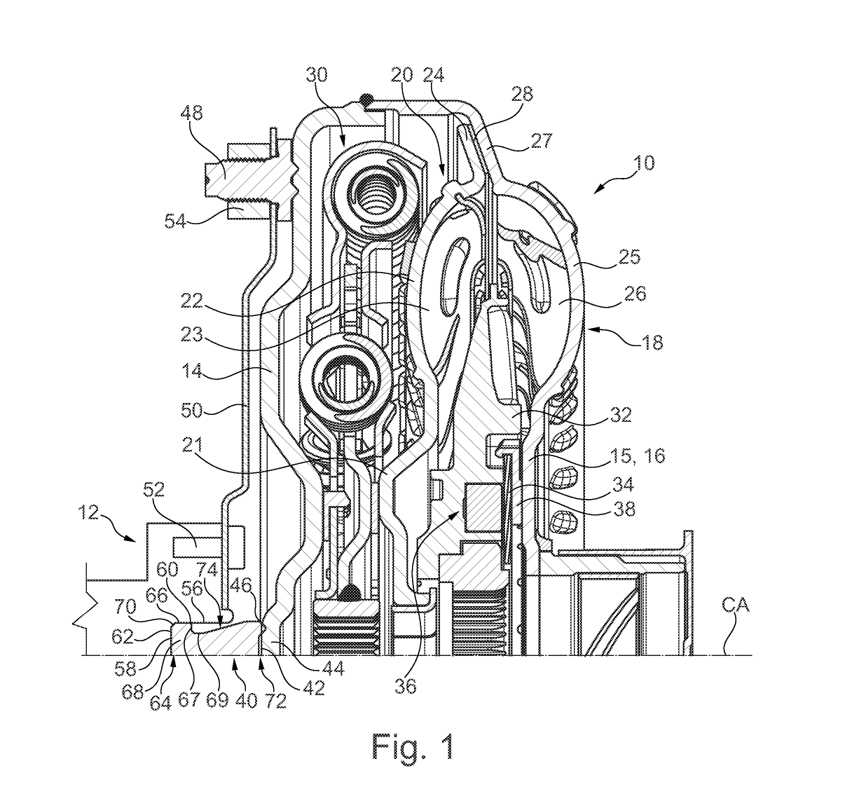

FIG. 1 shows a torque converter 10 aligned with an engine crankshaft 12 in accordance with an embodiment of the present invention. Torque converter 10 and engine crankshaft 12 are rotatable about a center axis CA. Torque converter 10 includes a front cover 14 for connecting to a crankshaft of an internal combustion engine and a rear cover 15 forming a shell 16 of an impeller or pump 18. Torque converter 10 also includes a turbine 20 that is configured to be axially slidable toward and away from impeller 18 to engage and disengage impeller 18 so as to form a lockup clutch. Turbine 20 includes a turbine shell 21 including a rounded blade supporting portion 22 for supporting a plurality of turbine blades 23 at a front cover side of the blades 23.

Radially outside of blade supporting portion 22, turbine shell 21 includes an outer radial extension 24 radially protruding outwardly from an outer circumference of blade supporting portion 22. Impeller shell 16 includes a rounded blade supporting portion 25 for supporting a plurality of impeller blades 26. Radially outside of blade supporting portion 25, impeller shell 16 includes a radially extending wall 27 radially protruding outwardly from an outer circumference of a blade supporting portion 25. A friction material 28 is bonded onto a surface of outer radial extension 24 for engaging radially extending wall 27. In other embodiments, instead of or in addition to being bonded to outer radial extension 24, friction material 28 may be bonded to radially extending wall 27. Turbine 20 is connected to a damper assembly 30 that is circumferentially drivable by turbine 20 and is positioned between turbine 20 and front cover 14. Torque converter 10 also includes a stator 32 between turbine 20 and impeller 18 and a one-way clutch 34 supporting stator 32. Stator 32 includes a centering plate 34 holding one-way clutch 36 in place within stator 32. A thrust washer 38 is also provided axially between stator 32 and impeller shell 16.

Torque converter 10 further includes a pilot 40 extending axially from an engine-side surface 42 of a flat center portion 44 of front cover 14. Pilot 40, front cover 12 and rear cover 14 together form a cover assembly of torque converter 10. Pilot 40 is concentric with front cover 14 and is fixed to front cover by a projection weld 46. Pilot 40 is used to align cover studs 48 with a flexplate 50 during installation of torque converter 10. Flexplate 50 is fixed to crankshaft 12 by a plurality of bolts 52 and is fixed to front cover 14 by nuts 54 received on studs 48 such that front cover 14 is drivable by crankshaft 12 via flexplate 50. To align front cover 14, pilot 40 is received in an envelope of crankshaft 12, which is in the form of a bore 56 formed in an end of crankshaft 12. Bore 56 is cylindrical and is defined by a radially extending surface 58 and an axially extending surface 60. A radially extending surface 62 of a free end 64 of pilot 40 axially contacts radially extending surface 58 of bore 56 and an axially extending surface 66 of pilot 40 radially contacts axially extending surface 60 of bore 56. In the embodiment shown in FIG. 1, free end 64 of pilot 40 is formed by a circular disc 68 including radially extending surface 62 and axially extending surface 66, with radially extending surface 62 having the shape of a flat circle and axially extending surface 66 having a cylindrical shape. Circular disc 68 includes a chamfer 70 extending between radially extending surface 62 and axially extending surface 66, and further includes a another radially extending surface 67 extending from an edge of axially extending surface 66 that is closest to base end 72 to a radially thinnest section 69 of pilot 40.

Pilot 40 is a single solid—i.e., not hollow—piece and further includes a base end 72 fixed to flat center portion 44 of front cover 14 and a tapered section 74 extending from base end 72. Tapered section 74 is positioned between base end 72 and free end 64 and decreases in size radially as pilot 40 extends axially away from front cover 14 such that base end 72 has a greater diameter than the entirety of tapered section 74. In the embodiment shown in FIG. 1, tapered section 74 has a frustoconical shape and base end 72 has a larger diameter than free end 64. The shape of pilot 40 may provide a sufficient projection weld area, may eliminate weak points and fits into the corresponding envelope of crankshaft 12.

In a preferred embodiment, the shape of pilot 40 may be created by a forming process before pilot 40 is welded to front cover 12. In other embodiments, pilot 40 may be formed to be cylindrical in shaped and then later machined before or after being welded to front cover 12 to create the shape of pilot 40. According, pilot 40 may be formed to include tapered section 74 and then fixed by base end 72 to front cover 12, or pilot 40 may be fixed by base end 72 to front cover 12, then machined to form tapered section 74.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A torque converter cover assembly comprising:
a front cover for facing an engine crankshaft; and
a pilot configured for aligning the front cover with the engine crankshaft, the pilot including a base end fixed to the front cover and a tapered section extending from the base end, the tapered section decreasing in size radially as the pilot extends axially away from the front cover.

2. The torque converter cover assembly as recited in claim 1 wherein the tapered section has a frustoconical shape.

3. The torque converter cover assembly as recited in claim 1 wherein the base end has a greater diameter than the entirety of the tapered section.

4. The torque converter cover assembly as recited in claim 1 wherein the base end is welded to the front cover.

5. The torque converter cover assembly as recited in claim 1 wherein a free end of the pilot is formed by a circular disc configured for contacting an axially extending of a bore in the engine crankshaft.

6. The torque converter cover assembly as recited in claim 1 further comprising a rear cover fixed to the front cover, the rear cover forming an impeller shell.

7. The torque converter cover assembly as recited in claim 1 wherein the pilot is a single solid piece.

8. A torque converter comprising the torque converter cover assembly as recited in claim 1.

9. A method of forming a torque converter comprising:
forming a front cover assembly including a front cover for facing an engine crankshaft and a pilot configured for aligning the front cover with the engine crankshaft, the pilot including a base end fixed to the front cover and a tapered section extending from the base end, the tapered section decreasing in size radially as the pilot extends axially away from the front cover.

10. The method as recited in claim 9 wherein the forming the front cover assembly includes forming the pilot to include the tapered section and then fixing the base end to the front cover.

11. The method as recited in claim 9 wherein the forming the front cover assembly includes fixing the pilot to the front cover and then machining the pilot to form the tapered section.

12. The method as recited in claim 9 wherein the tapered section has a frustoconical shape.

13. The method as recited in claim 9 wherein the base end has a greater diameter than the entirety of the tapered section.

14. The method as recited in claim 9 wherein the base end is welded to the front cover.

15. The method as recited in claim 9 wherein a free end of the pilot is formed by a circular plate.

16. The method as recited in claim 9 further comprising fixing a rear cover to the front cover, the rear cover forming an impeller shell.
